(19) United States
(12) Patent Application Publication
(10) Pub. No.: US 2023/0132562 A1
(43) Pub. Date: May 4, 2023

(54) CHARGING SYSTEM AND METHOD FOR AUTONOMOUS CHARGING OF AN ELECTRIC VEHICLE

(71) Applicant: Siemens Aktiengesellschaft, München (DE)

(72) Inventors: Peter Kummeth, Herzogenaurach (DE); Stefan Perras, Eichenau (DE); Johannes Richter, Fürth (DE)

(21) Appl. No.: 17/907,779

(22) PCT Filed: Feb. 5, 2021
(86) PCT No.: PCT/EP2021/052731

§ 371 Date: Aug. 29, 2022

(30) Foreign Application Priority Data
Feb. 27, 2020 (DE) 10 2020 202 533.9

(51) Int. Cl. B60L 53/35; B60L 53/18; B60L 53/16; B25J 9/16; H02J 7/00

(52) U.S. Cl. CPC B60L 53/35; B60L 53/18; B60L 53/16; B25J 9/1664; H02J 7/0042

(57) ABSTRACT

A charging system for autonomous charging of an electric vehicle with electric energy includes a vertical charging arm part, a charging cable or busbar connectible to the electric vehicle, and an elongate horizontal charging arm part extendible from the vertical charging arm part toward the electric vehicle. The horizontal charging arm part has a first drive system with a first linear operative direction corresponding to a longitudinal direction of the horizontal charging arm part, allowing a vehicle-side end of the horizontal charging arm part to move autonomously using the first drive system, relative to the electric vehicle relative to a first linear degree of freedom. A second drive system has a second linear operative direction moving the horizontal charging arm part autonomously relative to the electric vehicle relative to a second linear degree of freedom. A method for charging an electric vehicle using the charging system is also provided.

The present invention relates to a charging system for autonomous charging of an electric vehicle with electric energy, comprising a charging arm and a charging cable or a busbar, which is connectable to the electric vehicle to be charged. The invention also relates to a method for autonomous charging of an electric vehicle with such a charging system.

Numerous charging systems for charging electric vehicle are known from the prior art, in which a human user, in order to start the charging process, must connect a charging cable to the electric vehicle and must correspondingly disconnect this charging cable again from the electric vehicle at the end of the charging process. Due to the necessary interaction on the part of the user, such charging systems are not suitable for automated charging of autonomous vehicles, in which case a human user is no longer able or wishes to be active.

For the (partly) automated charging of electric vehicles, charging systems have been proposed in which, for example, a charging box mounted on a wall is connected to a robot arm which carries the charging cable and can plug this by way of an automated movement into the charging socket of the vehicle to be charged. This robot arm is based on a plurality of robot members arranged pivotably about rotary joints. Together with a vertical translational movement of the robot arm in the region of the charging box, a spatially limited positioning of the charging plug can thus be achieved in order to be able to plug the charging plug into a parked car. A disadvantage of this solution, however, is that it is relatively complex and the robot arm used is relatively costly. In addition, the robot arms are usually fixed rigidly in their mounting position and therefore cannot reach the different charging socket positions of different electric cars. In addition, such robot arms are typically unsuitable for long-term use outdoors.

The object of the invention is therefore to describe a charging system which overcomes the stated disadvantages and in particular is compatible with different vehicle lengths and is suitable for long-term use outdoors. In particular, the charging system should have the greatest freedom possible of positionability of the charging arm end and it should advantageously also allow the quickest possible charging. A further object is to describe a method for charging an electric vehicle with such a charging system.

These objects are achieved by the charging system described in claim 1 and the method described in claim 13.

The charging system according to the invention is configured for autonomous charging of an electric vehicle with electric energy. It comprises a vertical charging arm part as part of a superordinate charging arm. It also comprises a charging cable or a busbar. The charging cable or the busbar is connectable, with the aid of the charging arm, to the electric vehicle to be charged. The charging system also comprises a horizontal charging arm part of elongate shape which is extendible from the vertical charging arm part in the direction of the electric vehicle. The horizontal charging arm part has a first drive system with a first linear operative direction corresponding to a longitudinal direction of the horizontal charging arm part. The vehicle-side end of the horizontal charging arm part is thus movable autonomously, by means of the first drive system, relative to the electric vehicle with respect to a first linear degree of freedom. In addition, the charging system has a second drive system with a second linear operative direction, the horizontal charging arm part being movable autonomously relative to the electric vehicle with respect to a second linear degree of freedom by means of said second drive system.

The charging system can alternatively comprise either a charging cable or a busbar for electrical connection to the electric vehicle. If reference is made hereinafter by way of example to just one of these two alternatives, the other possibility shall always be considered to be disclosed as well.

The term “autonomous charging” shall be understood here generally to mean an automated charging process which requires no interaction on the part of a human user. Correspondingly, the term “autonomously movable” is understood to mean a type of movement that requires no human interaction. In conjunction with the present invention, the autonomous movability of the vehicle-side horizontal charging arm end is fundamentally along at least two, in particular independent, linear degrees of freedom of movement.

The charging system can thus generally have, as basic element, a charging arm which comprises a vertical charging arm part and (in particular carried thereby) a horizontal charging arm part. The vertical charging arm part shall be understood to mean an elongate sub-element of the charging arm with a vertical main direction component. It does not, therefore, have to be oriented exactly vertically. Correspondingly, the horizontal charging arm part shall be understood to mean an elongate sub-element of this charging arm with a horizontal main direction component.

It is not generally necessary for the charging arm to be stationary. This is possible, however, and under some circumstances advantageous. The charging arm may advantageously also be arranged movably, in particular it may be movable translationally on the whole. For this purpose, the charging arm, for example, can be arranged on a rail system so as to be movable horizontally. This can be in particular one of the stipulated two linear degrees of freedom of movement.

The charging system can comprise a vehicle region in which the vehicle to be charged can be positioned. The descried movement of the end of the horizontal charging arm part “towards the electric vehicle” and “with respect to the first linear degree of freedom” shall thus correspond to a movement in the direction of this vehicle region. In the vehicle region, the vehicle to be charged can be oriented substantially along a predefined vehicle longitudinal direction, which in particular corresponds to a local target direction of travel. This direction will be referred to hereinafter as the x-direction or by the term “horizontal longitudinal direction”. The horizontal spatial direction arranged perpendicularly thereto will be referred to here as the y-direction or as the “horizontal transverse direction”. The vertical spatial direction will be referred to as the z-direction.

The described movement of the charging arm end in the direction of the electric vehicle (with respect to the first linear degree of freedom) can be, in particular, a movement with a directional component in the horizontal transverse direction, that is to say in the y-direction. In this way, a charging plug can be plugged particularly easily into a charging socket arranged on the side of the vehicle. Here, the movement direction does not have to coincide exactly with the y-direction. Rather, in the case of this embodiment, it is sufficient if the movement direction has at least a sub-component in the y-direction. In particular in the case of a slightly inclined installation position of the charging socket on the vehicle, it may be advantageous if the movement direction, besides the y-component, also has a (usually smaller) z-component. A movement in the x-direction is not to be excluded here, particularly if the longitudinal direction of the vehicle is not oriented exactly along the target longitudinal direction (that is to say the x-direction of the charging system).

The movement in relation to the first translational degree of freedom is made possible by a first drive system of the horizontal charging arm part, which has a “first linear operative direction”. This feature shall be understood to mean that the movement brought about by the drive system is a linear movement. However, the first drive system does not have to be a fully linear drive with linear primary movement. For example, it can also be a spindle drive, in which a rotary primary movement is converted into a linear movement. It is essential, however, that the movement of the horizontal charging arm part (and thus also of the cable end) brought about by the drive system is a linear movement. This is a key difference from the charging system described at the outset with a robot arm, in which the movement of the charging arm end is brought about only by a plurality of rotary movements in the charging arm, specifically the rotations about rotatable robot joints.

Additionally to this first drive system, a second, linearly acting drive system is present, by means of which the horizontal charging arm part (and in particular the charging arm as a whole) is movable with respect to a second linear degree of freedom. The end of the horizontal charging arm part is hereby movable with respect to two independent linear degrees of freedom. The two linear movement directions do not necessarily have to be arranged exactly perpendicularly to one another, but in any case cannot lie parallel to one another. They advantageously form an angle of at least 45° with one another. The second linear movement direction can be, in particular, a movement with a substantial direction component in the z-direction or a movement with a substantial direction component in the x-direction. For example, in addition to the direction of the “plug-in movement”, a positionability in at least one other spatial direction is achieved.

A key advantage of the present invention is that, by means of the combination of at least two linearly acting drive systems, a relatively free, autonomous positionability of the vehicle-side charging arm end can be achieved. As a result of this free positionability, a compatibility of the autonomous charging system with a variety of different vehicles of different sizes and with different positions of the charging sockets can be achieved. There is thus no need for any particular adaptation to the vehicles for the charging with the charging system according to the invention.

Numerous embodiments which are easily implemented are known for the described linearly acting drive systems and can be controlled in principle in an automated fashion within an autonomous system. A further key advantage is that linearly acting drive systems of this kind can be formed in a relatively robust manner and/or in a manner easily enclosed with respect to external influences. A charging system configured for operation outdoors can thus be realized relatively simply. Furthermore, this solution can be realized relatively cost-effectively and with a low maintenance requirement in comparison to the robot arms based on rotary joints. This is true in particular if the charging cable or the busbar to be carried by the charging arm is configured for the transport of direct current of high current strengths and is therefore relatively heavy.

The method according to the invention is used for autonomous charging of an electric vehicle with a charging system according to the invention. The method comprises at least the following steps:

(a) positioning the electric vehicle to be charged in a vehicle region of the charging system,

(b) autonomously ascertaining a target position for the vehicle-side end of the horizontal charging arm part,

(c) autonomously positioning the vehicle-side end of the horizontal charging arm part in the target position, with at least the sub-step:
(c1) extending the horizontal charging arm part in the direction of the electric vehicle by means of the first drive system.

The advantages of the method according to the invention are provided analogously to the advantages, described further above, of the charging system according to the invention. In particular, no part of the charging process requires any interaction on the part of a human user. The position ascertainment in step (b) and the positioning in step (c) are performed here in any event autonomously by the charging system. The entry or positioning of the vehicle in step (a) can be performed in principle autonomously, so that particularly advantageously an autonomously driving vehicle can in this way be charged fully autonomously. In principle, however, a human driver may also position the vehicle in the charging system in step (a), whereupon only steps (b) and (c) are then performed in an automated manner.

Advantageous embodiments and developments of the invention will become clear from the claims dependent on claims 1 and 13 as well as from the following description. The described embodiments of the charging system and of the method can be combined here generally advantageously with one another.

For example, an angle can be formed generally advantageously between the first linear operative direction and the second linear operative direction, said angle being between 45° and 135°. This angle is particularly advantageously between 60° and 120°, in particular in a range of 90°+/−10°. At an angle in one of the stated ranges, the operative directions are significantly different, so that sufficiently independent linear degrees of freedom can be assumed. The two stated operative directions, however, in particular do not have to lie exactly perpendicularly to one another. For example, the first operative direction can have an inclined position in space, and for example can have both a y- and a z-component. This may be advantageous particularly in the case of charging sockets oriented at a slight incline on the vehicle, in order to be able to move the charging plug correspondingly at an incline towards a charging socket of this kind. By contrast, the second linear operative direction can be oriented for example primarily along the z-direction or along the x-direction.

In accordance with a generally advantageous embodiment, the first linear operative direction of the first drive system forms an angle α of absolute value of at most 45° and particularly advantageously of at most 30° with the above-defined y-direction. The first linear operative direction will also be referred to hereinafter as the a-direction. The vehicle-side end of the horizontal charging arm part can thus be moved via the first drive system with a main direction component in the horizontal transverse direction towards the vehicle. The vehicle-side end of the horizontal charging arm parts is optionally also movable autonomously in a correspondingly opposite direction (that is to say in a negative a-direction) away from the vehicle. This reverse movement can also be brought about for example by the first drive system; alternatively, however, it is also possible by way of a further drive system. The first linear operative direction can particularly advantageously be oriented in an angular range of +/−10° about the y-direction and in particular may even correspond substantially to the y-direction. The vehicle-side end of the horizontal charging arm part can thus be brought towards the vehicle by way of a horizontal movement.

Alternatively or additionally, the second linear operative direction of the second drive system can advantageously form an angle of at most 10° with the z-direction. The second linear operative direction will also be referred to hereinafter as the b-direction. The b-direction can particularly advantageously correspond substantially to the z-direction. In this embodiment the horizontal charging arm part and therefore also the vehicle-side end of the horizontal charging arm part can be moved in the vertical spatial direction via the second drive system. In combination with the first linear degree of freedom already described, this allows, on the whole, a very comprehensive positionability of the charging arm end with respect to a vehicle parked in the region of the charging system and in particular with respect to the position of the charging socket of said vehicle. Here, the second drive system can move in particular the horizontal charging arm part vertically relative to the ground. Alternatively, however, the horizontal charging arm part can also be movable vertically together with the vertical charging arm part or at least with parts of the vertical charging arm part.

In accordance with a preferred embodiment, the charging system has a third drive system with a third linear operative direction, by means of which the vertical charging arm part is movable autonomously relative to the electric vehicle with respect to a third linear degree of freedom. By way of the movement of the vertical charging arm part, the horizontal charging arm part mounted thereon and accordingly also the vehicle-side charging arm end mounted on the horizontal charging arm part are also moved. With the presence of such a further degree of freedom, the free positionability of the charging arm relative to the parked vehicle is increased further still. In particular, in this embodiment, a positioning of the charging arm end with an arbitrarily selectable x-, y- and z-coordinate can be performed.

In a preferred variant of this embodiment, the third linear operative direction of the third drive system forms an angle of at most 15° with the x-direction. This x-direction is understood to mean the “target longitudinal direction” of the vehicle to be charged. It should be noted that in the case of the individual charging operations and in the case of a slightly skewed parked position, there may be a deviation of the actual longitudinal direction of the vehicle from this superordinate x-direction of the charging system.

Alternatively to the previously described embodiment, the second linear operative direction can, however, also correspond in principle substantially to the x-direction, wherein the horizontal charging arm part (either on its own or in particular together with the vertical charging arm part) is then thus movable along the target longitudinal direction of the vehicle already with the second drive system.

Generally and independently of the exact number and orientation of the degrees of freedom of movement, the charging system, in an advantageous embodiment, can have a pivot and/or tilt unit in the vehicle-side end region of the horizontal charging arm part. The vehicle-side end of the horizontal charging arm part is movable by means of this unit with respect to at least one degree of freedom of rotation. The unit is particularly advantageously a pivot-tilt unit with a movability with respect to at least two degrees of freedom of rotation. These degrees of freedom of rotation can be configured such that in particular a charging plug arranged at this charging arm end can be pivoted within the xy-plane and in the yz-plane. A very comprehensive selection of the orientation of a charging plug carried by the charging arm relative to the charging socket of the vehicle is thus possible. In particular, inclined arrangements of the charging socket can also be tolerated. By way of the tilt movement, the charging plug can be oriented in respect of an inclined plugging direction of the charging plug into the charging socket. Due to the xy-pivot movement, the charging plug can be adapted in respect of a position of the charging socket on the vehicle arranged at an incline within this plane or also in respect of a deviation of the exact parked position from the exact target longitudinal direction. Optionally, the pivot-tilt unit can be configured such that it additionally allows the movement with respect to a third degree of freedom of rotation. This can be, in particular, a rotary movement within the xz-plane. An installation position of the charging socket that is rotated in relation to the basic position of the charging plug can hereby be compensated, additionally. The charging system can generally advantageously be configured such that, by way of the pivot and/or tilt unit, an autonomous rotation in respect of the described degrees of freedom of rotation is made possible.

Generally advantageously, the charging system can have a charging plug in the vehicle-side end region of the horizontal charging arm part. The charging cable can be plugged, via such a charging plug, into a charging socket of the vehicle to be charged. In this embodiment, it is particularly preferred if the charging system has a fourth drive system with a fourth linear operative direction, wherein this fourth drive system allows the charging plug to be plugged into and/or unplugged from a charging socket of the vehicle to be charged. The fourth linear operative direction is also referred to hereinafter as the d-direction. It can coincide with the above-described a-direction of the first drive system or, particularly advantageously, can form therewith an angle different from zero, in particular an angle between −45° and 45°. By way of the above-described pivot-tilt unit, the angle between the a-direction and the d-direction can in particular be adapted autonomously to the conditions of the vehicle currently to be charged. It can thus advantageously be achieved that the extension direction of the horizontal charging arm part (a-direction) can be defined universally for the charging system, whereas the plug-in direction (d-direction) can be dynamically adapted for each charging process. The angle between the a-direction and the d-direction can be adjustable for example in a range between −30° and 30°, in particular even in a range between −45° and 45°.

The fourth drive system can optionally be configured such that it also allows a movement in a negative d-direction and thus an unplugging of the charging plug from the charging socket. Alternatively, a further drive can also be provided for this reverse movement, in the region of the charging arm end.

Various suitable drive types exist for the individual drive systems of the charging system. The individual linearly acting drive systems can be either the same as one another or also configured differently. For example, the first linearly acting drive system can be formed in particular by a push-pull chain system and can comprise accordingly a linearly movable push-pull chain. A push-pull chain drive of this kind is described in the application filed in the name of the same applicant on the same day with the title “Charging system and method for charging an electric vehicle”, which should therefore be incorporated in the content of the disclosure of the present application. Alternatively, however, the first drive system can also be a telescopic system, a slide system and/or a rail system, in which a plurality of sub-elements are connected to one another so as to be movable linearly. These drive forms are advantageously suitable also for the second and the third linearly acting drive system. The actual drive element of a linearly acting drive system of this kind can be, for example, a spindle drive, a belt drive, a rack-and-pinion drive, or a true linear drive (with primary linear drive direction). It is particularly preferred if the second drive system comprises a linearly movable telescopic or slide system, by means of which the horizontal charging arm part is movable vertically relative to the vertical charging arm part. It is particularly preferable for the third drive system if this comprises a rail system, so that the vertical charging arm part together with the horizontal charging arm part is movable horizontally on one or more rails.

In accordance with a generally advantageous embodiment, the charging cable or the busbar of the charging system is configured for charging the electric vehicle with direct current. In other words, it is thus a DC cable. A DC cable of this kind particularly advantageously allows very rapid charging of the vehicle with a high amount of electric energy. A particularly short charging time and thus a particularly high productive efficiency of an autonomous vehicle can be achieved here. A DC cable of this kind can comprise, for example, insulated stranded copper wires (in particular insulated flat stranded copper wires) and/or copper cables and/or insulated braided copper fabric strips. The actual DC cable can be guided advantageously in a drag chain, which allows reliable protection against mechanical damage to the cable.

The DC cable can be configured in particular generally for a charging current of at least 125 A, for example for a charging current in the range between 125 A and 1000 A. Alternatively or additionally, the cable can be configured for a charging voltage of at least 125 V, for example a voltage in the range between 125 V and 1500 V. At such high voltages and/or currents, a particularly short charging time can be achieved. However, a relatively high cable mass results from the required current-carrying capabilities. For example, the length-specific mass of the cable can lie above 1 kg/m and in particular even above 3 kg/m. Alternatively to the DC cable, a busbar can be used.

The charging system is generally advantageously configured for use outdoors. For this purpose, the charging system as a whole and in particular both the charging arm and the (in particular linearly acting) drive systems provided can be configured for IP protection class IP54. Such a configuration for a charging system according to the present invention is relatively easily realized, in contrast to a robot arm that is extendable on the basis of rotary joints. The optionally present pivot-tilt unit is also advantageously sufficiently robust or enclosed, such that it also satisfies the requirements of the above-stated protection class. This is more easily realized for such an individual rotatably movable region of the charging system than for multiple rotary joints in a more complex robot arm.

In accordance with a generally advantageous embodiment, the charging system comprises at least one sensor unit, by means of which the position of a charging unit of the electric vehicle to be charged can be determined. In particular, the corresponding position can be determined autonomously using this sensor unit. The stated charging unit of the vehicle is in particular a charging socket, into which a charging plug of the charging system is then plugged. However, the invention is not intended to be limited to this kind of contacting. For example, two or more contact elements (on the vehicle and on the charging system) can in principle also be brought into electrically conductive contact without plugged connection, or, conversely, a charging socket can be mounted on the charging system and a charging plug on the vehicle. For these, more general cases as well, the stated “charging unit” is intended to denote the unit of the vehicle in the region of which the electrical connection required for the charging is established.

The sensor unit can comprise in particular an optical sensor, for example an optical camera. Furthermore, the charging system can advantageously comprise an evaluation unit, by means of which, on the basis of the measured data from the sensor unit, a target position of the vehicle-side end of the horizontal charging arm part can be determined. In addition to the target position, a target orientation of the charging arm end (and in particular of a charging plug arranged thereon) can optionally be determined. For this purpose, the evaluation unit can comprise a trainable neural network, by means of which the target position and optionally the target orientation can be determined.

The charging system can additionally generally advantageously comprise a control unit, by means of which the drive systems provided (both the linearly acting drive systems and the optionally provided rotatably movable unit) can be controlled in an automated manner. The control unit is then preferably set up to effect an autonomous positioning, by control of the drive systems, in accordance with the target position ascertained by the evaluation unit in combination with the sensor unit.

In accordance with a further generally advantageous embodiment, the charging system comprises two charging devices, wherein each charging device comprises a vertical charging arm part, a charging cable or a busbar, and a horizontal charging arm part of elongate shape that is extendible from the vertical charging arm part in the direction of the electric vehicle. Here, the charging devices are preferably arranged such that the electric vehicle to be charged can be positioned between them. A vehicle to be charged can thus advantageously be charged by the same charging system in principle both from the right and from the left. There is thus no need for any adaptation or special selection of the charging system depending on the side of the charging unit present. The charging system therefore can be used in a particularly universal manner.

In accordance with an advantageous embodiment of the method, in step (b) a target orientation of the charging arm end and in particular of a charging plug arranged there can be ascertained autonomously in addition to the target position of the charging arm end.

As a further sub-step within step (c), the following additional sub-step can be provided:

(c2) positioning the horizontal charging arm part by means of the second drive system.

This positioning with respect to the second linear degree of freedom is also performed autonomously in accordance with the target position of the charging arm end. This step is optional, since the position of the horizontal charging arm part (and thus of the charging arm end) with respect to the second linear degree of freedom can be correctly selected already for the current vehicle. However, when it is performed it is preferably performed prior to the extension of the horizontal charging arm part in step (c1).

As a further sub-step within step (c), the following additional sub-step can be provided:

(c3) positioning the vertical charging arm part by means of the third drive system.

This positioning with respect to the third linear degree of freedom is also performed autonomously in accordance with the target position of the charging arm end. This step is also optional, since the position of the vertical charging arm part (and thus also of the horizontal charging arm end) with respect to the third linear degree of freedom can be correctly selected already for the current vehicle. If it is required, however, it is preferably performed prior to the extension of the horizontal charging arm part in step (c1). It can be performed before or after step (c2).

If the charging system has an additional rotatably movable unit in the end region of the horizontal charging arm part, the method can comprise one or more of the following optional steps:

(c4) tilting the vehicle-side end of the horizontal charging arm part with respect to a first degree of freedom of rotation,

(c5) pivoting the vehicle-side end of the horizontal charging arm part with respect to a second degree of freedom of rotation,

(c6) rotating the vehicle-side end of the horizontal charging arm part with respect to a third degree of freedom of rotation.

All provided sub-steps of step (c) can be controlled in particular autonomously via a control unit of the charging system.

In addition, the method can comprise optionally the following additional step:

(d) plugging a charging plug at the vehicle-side charging arm end into the charging socket of the vehicle.

This step can be performed in particular subsequently to step (c), that is to say once the charging arm end has been positioned correctly. The provision of step (d) is preferred, but not mandatory, since the electrical connection can be established in principle also without a plugged connection.

Subsequently to step (d), the method can advantageously comprise the following further steps (in particular in the stated order):

(e) starting the charging process, in particular by switching on a charging current,

(f) ending the charging process, in particular by switching off the charging current,

(g) unplugging the charging plug (optional), (h) returning the horizontal charging arm part,

(i) removing the vehicle from the vehicle region.

In accordance with a further advantageous embodiment of the method, step (b) can comprise at least the following sub-steps:

(b1) detecting measurement data, which are dependent on the position of a charging unit of the electric vehicle, by means of a sensor unit of the charging system,

(b2) determining the target position for the vehicle-side end of the horizontal charging arm part by means of an evaluation unit of the charging system on the basis of the detected measurement data.

The determination of the target position can be performed in particular via an automatic image recognition from the data of an optical sensor. In step (b2), besides the target position, a target orientation for the charging arm end can optionally also be determined from the detected measurement data. Not only can the position then be determined, for example by means of the image recognition, but also the orientation of the charging unit of the vehicle. In particular for this case it is advantageous if an adaptation of the orientation of the charging arm end is then made via one or more of the above-described rotary movements in (c4) to (c6).

In accordance with a further advantageous embodiment of the method, the determination of the target position from the measurement data can be performed in step (b2) at least in part by means of a trainable neural network of the evaluation unit. In other words, the autonomous determination of the position data for the control unit can be carried out by way of artificial intelligence.

The invention will be described hereinafter on the basis of some preferred exemplary embodiments with reference to the appended drawings, in which:

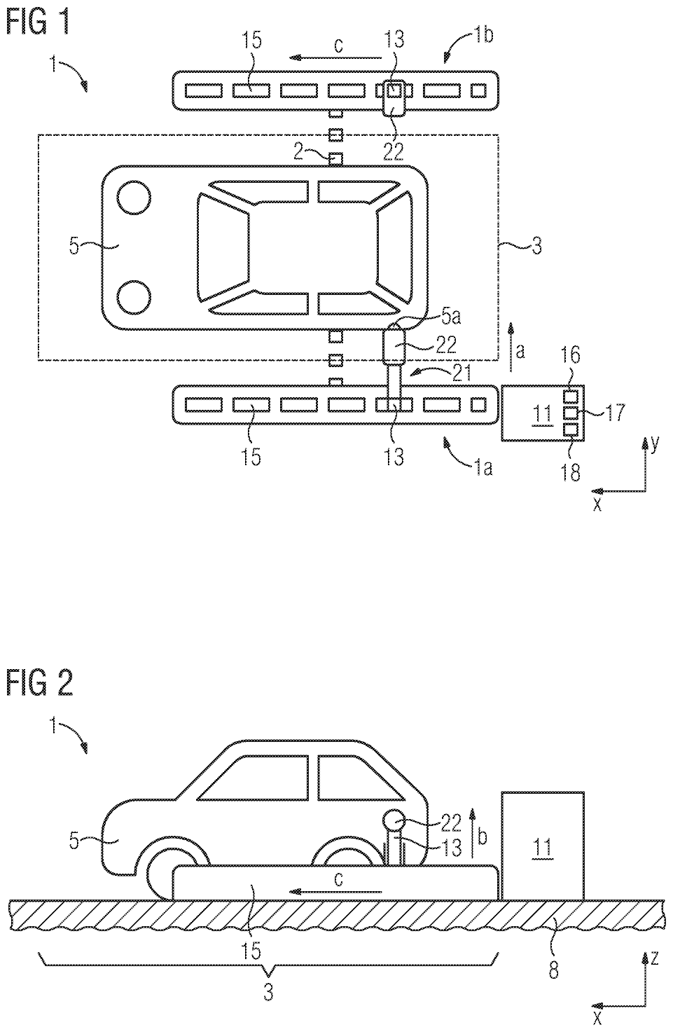

FIG. 1 shows an illustration of a charging system according to a first exemplary embodiment in a schematic view,

FIG. 2 shows the charging system of FIG. 1 in a schematic longitudinal view,

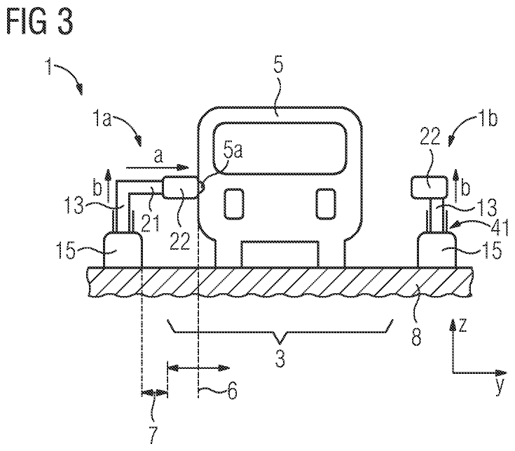

FIG. 3 shows the charging system of FIGS. 1 and 2 in a schematic cross-section, and

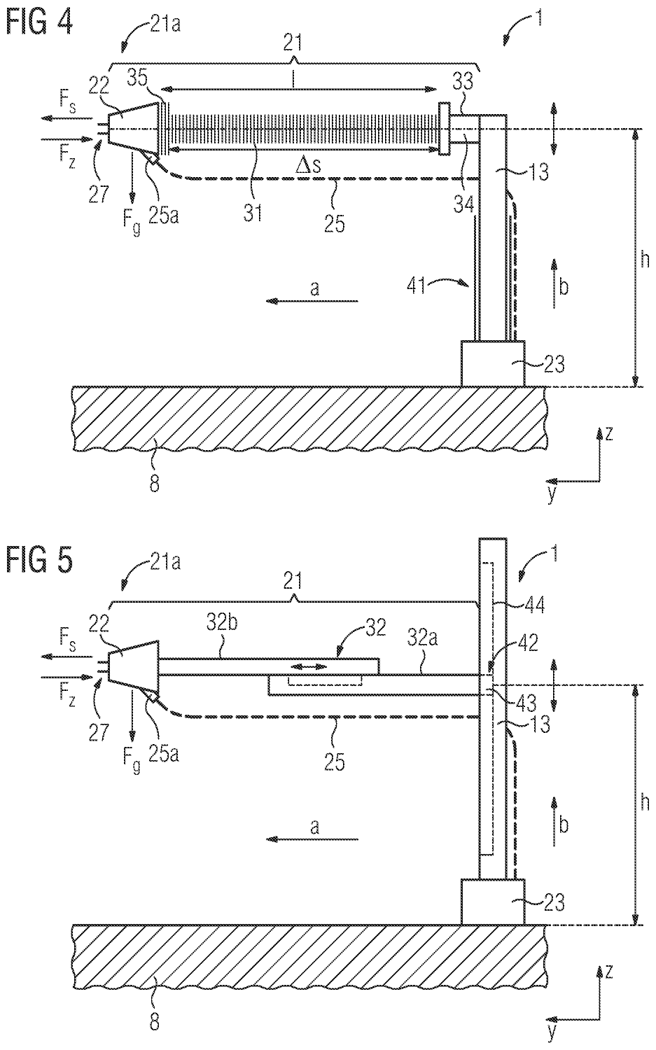

FIGS. 4 to 7 show detailed views of charging systems according to further exemplary embodiments in schematic cross-section.

In the figures, like or functionally like elements are provided with like reference signs.

FIG. 1 shows a charging system 1 according to a first exemplary embodiment of the invention in a schematic plan view in the x-y-plane. The charging system 1 comprises a vehicle region 3, in which an electric vehicle 5 to be charged can be positioned. In this case, the x-direction is the horizontal longitudinal direction of the vehicle, and the y-direction is the horizontal transverse direction perpendicular thereto. The z-direction, not shown here, is the vertical spatial direction perpendicular to the drawing plane. The corresponding side view of the charging system 1 in the x-z-plane is shown in FIG. 2, and the corresponding schematic cross-sectional illustration is shown in FIG. 3.

The charging system in this example has two charging devices 1a and 1b, by means of which the electric vehicle can be charged both from the right and from the left. In principle, however, only one such charging device is sufficient to realize the inventive concept. The two charging devices are electrically connected by a transverse connection 2 indicated here only very schematically. In the region of the first charging device 1a, there is arranged a charging post 11, via which both the charging devices are electrically connected to a superordinate power grid. The charging post 11 thus serves to control and forward a charging current to the other sub-elements of the charging system 1.

The charging system 1 also comprises a sensing unit 16, which serves to ascertain the vehicle position and in particular to ascertain the position of the charging socket 5a on the vehicle 5. For example, the sensor unit 16 can be an optical camera. In FIG. 1, the sensor unit 16 is shown on the charging post merely by way of example. Alternatively, such a sensor unit can also be arranged at another point, in particular particularly preferably at a vehicle-side charging arm end 21a. Here, the arrangement of such a sensor unit 16 in only one of the charging devices provided is sufficient in principle. The data measured by the sensor unit 16 are in any case forwarded to an evaluation unit 17, which is shown here, merely by way of example, likewise in the region of the charging base. Alternatively, such an evaluation unit 17 can also be arranged at another point, in particular particularly preferably in the region of the rail system 15. The evaluation unit automatically ascertains from the sensor data a target position for the vehicle-side end 21a of the horizontal charging arm part. Furthermore, the charging system comprises a control unit 18, by means of which the movements of the vertical (13) and horizontal charging arm part (21) and their sub-components can be controlled. This control unit can also be arranged in principle in another region of the charging system.

The vehicle 5 in FIG. 1 has a charging socket 5a in the left rear vehicle region. The shown example vehicle is therefore charged from the first charging device 1a. In order to produce an electrical connection between the charging post 11 and the charging socket 5a of the vehicle, each of the charging devices 1a, 1b has a charging cable, not shown here in greater detail. In order to bring this charging cable into contact with the charging socket 5a, each of the charging devices furthermore comprises three drive systems 31, 41 and 15 with linear operative directions, which together allow a movement of the vehicle-side charging arm end in a plurality of spatial directions. The charging system 1 of the first exemplary embodiment thus allows a translational movement of the charging arm end in question in all three spatial directions x, y and z. This is not absolutely necessary, however. Rather, it is sufficient if movements with respect to two translational degrees of freedom are made possible.

As essential components, each of the charging devices 1a and 1b here comprises a vertical charging arm part 13. These vertical charging arm parts 13 extend in the z-direction and raise the charging cable to the height of the charging socket 5a. The vertical charging arm part in question is arranged movably in the x-direction via an associated rail system 15. This rail system 15 forms a drive system with the linear operative direction c, wherein this operative direction c coincides here with the x-direction. The vertical charging arm part is thus movable and not stationary. The charging system can thus be adapted to different x-positions of the charging socket on the vehicle and/or to different parked positions of the vehicle.

The vertical charging arm part 13 in question carries an associated horizontal charging arm part 21, by means of which the charging cable can be guided in the y-direction into the region of the charging socket 5A. This horizontal charging arm part 21 can be extended in the direction of the vehicle to be charged and retracted in the direction of the vertical charging arm part 13.

It can be seen in FIGS. 1 and 3 that the horizontal charging arm part 21 of the first charging device 1a is extended and the horizontal charging arm part (not visible here) of the second charging device 1b is retracted. The horizontal charging arm part in question, at the vehicle-side end, carries a charging head, in which there is integrated a charging plug, not shown here in greater detail.

The vertical height (that is to say the z-position) of the charging head 22 can be adapted to the height of the particular charging socket. This possibility can be realized in different ways, for example by changing the vertical extent of the vertical charging arm part 13 via the shown telescopic system 41. Alternatively, for example, the vertical position of the horizontal charging arm part 21 on the vertical charging arm part 13 can also be varied via a slide system.

The y-position of the charging head 22 can be adapted to the position of the charging socket 5a by extending the horizontal charging arm part on the relevant vehicle side by a suitable distance in the direction of the vehicle. In this way, differences in the width of the vehicles to be charged and differences in the various parked positions can be compensated. Due to these differences, the vehicle side 6 facing the relevant vertical charging arm part 13 can have different y-positions, as indicated by a double arrow around the position 6 in the lower part of FIG. 3. The horizontal charging arm part 21 therefore has a correspondingly large possible extension path, in order to bridge the varying horizontal distance between the vertical charging arm part and the particular charging socket. The minimum necessary extension path of the horizontal charging arm part is provided here by the minimum safety distance 7, which must be ensured when parking between the retracted horizontal charging arm part and the corresponding vehicle side 6. This safety distance 7 can lie for example in the region of approximately 20 cm.

In the exemplary embodiment of FIGS. 1 to 3, the horizontal charging arm part 21 comprises a push-pull chain as carrying element, so that the extension and retraction of the horizontal charging arm part can be realized by a corresponding extension and retraction of the push-pull chain. The part of the horizontal charging arm part between the vertical charging arm part 13 and charging head 22 is formed here primarily by this push-pull chain. This push-pull chain system thus also forms a drive system with linear operative direction a, wherein this operative direction a coincides here with the y-direction.

A cross-sectional illustration of a charging system 1 according to a second exemplary embodiment of the invention is shown in FIG. 4. This charging system, for example, can be constructed on the whole similarly to the charging system from FIGS. 1 to 3. Here, FIG. 4 shows a detailed view in the region of the vertical charging arm part 13, wherein in FIG. 4 the horizontal charging arm part 21 is extended. The entire charging arm is arranged on a base 23 so as to be movable in the x-direction via an associated rail system 15 (not shown in greater detail in this sectional view).

As can be clearly seen in FIG. 4, in the extended state a large part of the horizontal charging arm part 21 is formed by a push-pull chain 31 of length l. This push-pull chain 31 has multiple chain links (not shown here in greater detail), which in the extended state engage in one another interlockingly, so that the push-pull chain is self-stiffening. In the retracted state, this push-pull chain by contrast is rolled up and thus accommodated in a space-saving manner in a chain box 33, which is arranged in the region of the vertical charging arm part 13. At the vehicle-side end 21a of the horizontal charging arm part, the push-pull chain 31 has an endpiece 35, which carries the charging head 22. A charging plug 27 is integrated in this charging head 22 and can be plugged into a matching charging socket of a vehicle to be charged.

The charging head furthermore carries a vehicle-side end 25a of a charging cable 25, which is entrained by the horizontal charging arm part in the direction of the vehicle to be charged. In the example of FIGS. 4 and 5, this charging cable 25 is thus carried in a manner hanging relatively freely from the horizontal charging arm part 21. It is mechanically fixed merely at a point to the charging head 22 and additionally in the region of the vertical charging arm part 13. Alternatively, however, the charging cable can also be guided closer to the push-pull chain 31 and in particular can also be integrated therein. The maximum extension path Δs is given generally by the difference in the chain length l between the maximally extended state and the maximally retracted state. For example, with a sufficiently long chain strand, an extension path in the range between 20 cm and 150 cm can be realized.

With a self-stiffening embodiment of the push-pull chain 31, a sufficiently high rigidity can be achieved, so that the push-pull chain is self-supporting. It is thus rigid enough in particular to carry not only its own weight, but also to support the weight of the charging cable 25 and of the charging head 22 and additionally to apply the necessary plugging force for plugging in the charging plug. The height h of the horizontal charging arm part 21 above the ground 8 is to be substantially maintained over the extension path. For example, the force of gravity Fg acting in the region of the charging head does not result in an excessive vertical sagging of the horizontal charging arm part. A slight drooping towards the vehicle, for example in the range of a few millimeters to a few centimeters, can also certainly be tolerated under some circumstances. It is merely essential that the horizontal charging arm part is sufficiently rigid to extend the charging head horizontally far enough in the direction of the charging socket and at the same time to meet the height of the charging socket of the vehicle within the scope of the necessary positioning accuracy.

The push-pull chain 31 of the horizontal charging arm part is configured to transfer to the charging head 22 both a pushing force Fs towards the vehicle and a pulling force Fz away from the vehicle. Here, the pushing force serves to plug the charging plug 27 into the charging socket. Conversely, the pulling force Fz serves to remove the charging plug 27 again from the charging socket. The particular movement of the push-call chain in the y-direction is brought about here by a drive 34, which is arranged here in the region of the chain box.

A detailed view of a charging system 1 according to a third exemplary embodiment of the invention is shown in FIG. 5. The main difference from the charging system of FIG. 4 is that the first and the second linearly acting drive system are realized differently. For the rest, however, the charging system is embodied similarly to the previous example. For example, the first drive system is realized here as a slide system 32, in which the horizontal charging arm part 21 has a plurality of slide elements, which are movable in translation relative to one another along the first linear operative direction a. By way of example, only two arm elements 32a and 32b are shown here, specifically a slide 32b which can slide on a carrier element 32a. However, more sub-elements of this kind can also be provided, wherein the relative movement of adjacent elements is then to run always along the same operative direction a. Here too, the a-direction coincides with the y-direction of the system.

A further difference from the example of FIG. 4 is that the second drive system is also realized as a slide system 42, in which one slide 43 (which carries the horizontal charging arm part 21) can slide up and down in a vertical guide rail 44 within the vertical charging arm part. The second linear operative direction therefore also corresponds here substantially to the z-direction.

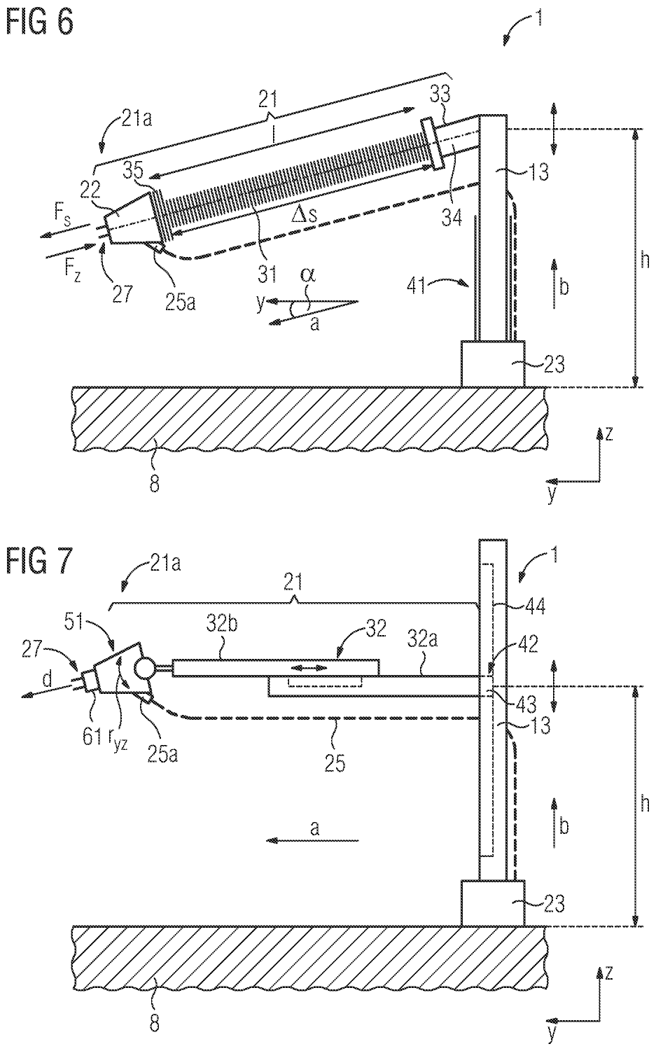

A detailed view of a charging system 1 according to a fourth exemplary embodiment of the invention is shown in FIG. 6. The first and second drive are again realized similarly to the example of FIG. 4. The main difference from the charging system of FIG. 4 is that the horizontal charging arm part is mounted on the vertical charging arm part in a manner suspended at an incline. Accordingly, the first linear operative direction a is also not parallel to the y-axis, and instead forms an angle α therewith. This facilitates a plugging of the charging plug 27 into a charging socket arranged correspondingly at an incline. In order to allow an adaptation to the installation position of the charging socket to be approached, the corresponding angle at which the horizontal charging arm part 21 protrudes from the vertical charging arm part can also generally advantageously be variable via an autonomously controllable tilt element, not shown here in greater detail.

A detailed view of a charging system 1 according to a fifth exemplary embodiment of the invention is shown in FIG. 7. In this case, the first and the second drive are realized similarly to the example of FIG. 5. The main difference from the charging system of FIG. 5 is that the charging head in the end region 21a of the horizontal charging arm part has a pivot-tilt unit 51. This allows the charging head to be tilted in the yz-plane (as indicated by the double arrow r_{yz}) and additionally allows a second rotation, for example a pivoting in the xy-plane. As a result, even in the case of a horizontal charging arm part 21, the orientation of the charging plug 27 can be adapted to a charging socket installed at an incline. A rotation in the xz-plane is additionally possible optionally. Furthermore, the charging system 1 of FIG. 7 has a fourth linearly acting drive system 61. The linear operative direction of this drive system is denoted by d. Here, d (as in the shown position of the pivot-tilt unit 51) can optionally lie at an incline depending on the position of the pivot-tilt unit 51, that is to say can form an angle different from zero with the y axis and thus also with the operative direction a. The fourth drive system, for example, can comprise a true linear drive. Generally and regardless of the apparatus set up, the travel path of this fourth drive can be relatively short. For example, a travel path of less than 10 cm is generally sufficient in order to plug a charging plug 27 into a corresponding charging socket. Additionally to such a plug-in movement (in the positive d-direction), the fourth drive system 61 can also be configured to bring about an autonomous movement in a negative d-direction, in order to be able to automatically unplug the charging plug again, once the charging process is complete.

### LIST OF REFERENCE SIGNS

1 charging system
1a first charging device
1b second charging device
2 transverse connection
3 vehicle region
5 electric vehicle
5a charging socket (charging unit)
6 vehicle side
7 safety distance
8 ground
11 charging post
13 vertical charging arm part
15 rail system (third drive system)
16 sensor unit
17 evaluation unit
18 control unit
21 horizontal charging arm part
21a vehicle-side end of the charging arm
22 charging head
23 charging arm base on rail system
25 charging cable
25a vehicle-side end of the charging cable
27 charging plug
31 push-pull chain (first drive system)
32 slide system (first drive system)
32a first horizontal arm element (support element)
32b second horizontal arm element (slide)
33 chain box
34 chain drive
35 endpiece
41 telescopic system (second drive system)
42 slide system (second drive system)
43 slide
44 guide rail
51 pivot-tilt unit
61 fourth drive system
α angle
a first linear operative direction
b second linear operative direction
c third linear operative direction
d fourth linear operative direction
Fg force of gravity
Fs pushing force
Fz pulling force
h height of the horizontal charging arm part
l length of the extended push-pull chain
r_{yz} second degree of freedom of rotation
x horizontal longitudinal direction
y horizontal transverse direction
z vertical spatial direction

1-15. (canceled)

16. A charging system for autonomous charging of an electric vehicle with electric energy, the charging system comprising:
a vertical charging arm part;
a charging cable or a busbar configured to be connected to the electric vehicle to be charged;
a horizontal charging arm part being elongate and configured to be extended from said vertical charging arm part toward the electric vehicle, said horizontal charging arm part having a longitudinal direction and a vehicle-side end;
said horizontal charging arm part having a first drive system with a first linear operative direction corresponding to said longitudinal direction of said horizontal charging arm part, said first drive system autonomously moving said vehicle-side end relative to the electric vehicle with respect to a first linear degree of freedom; and
a second drive system with a second linear operative direction, said second drive system autonomously moving said horizontal charging arm part relative to the electric vehicle with respect to a second linear degree of freedom.

17. The charging system according to claim 16, wherein said first linear operative direction and said second linear operative direction together form an angle of between 45° and 135°.

18. The charging system according to claim 16, wherein said first linear operative direction of said first drive system forms an angle of at most 45° with a horizontal transverse direction of the charging system.

19. The charging system according to claim 16, wherein said second linear operative direction of said second drive system forms an angle of at most 10° with a vertical spatial direction.

20. The charging system according to claim 16, which further comprises a third drive system with a third linear operative direction, said third drive system autonomously moving said vertical charging arm part relative to the electric vehicle with respect to a third linear degree of freedom.

21. The charging system according to claim 20, wherein said third linear operative direction of said third drive system forms an angle of at most 10° with a horizontal longitudinal direction of the charging system.

22. The charging system according to claim 16, which further comprises at least one of a pivot or tilt unit disposed in said vehicle-side end region of said horizontal charging arm part, said at least one of a pivot or tilt unit moving said vehicle-side end of said horizontal charging arm part with respect to at least one degree of freedom of rotation.

23. The charging system according to claim 16, which further comprises a charging plug disposed in said vehicle-side end region of said horizontal charging arm part, and a fourth drive system with a fourth linear operative direction, said fourth drive system allowing said charging plug to be at least one of plugged into or unplugged from a charging socket of the vehicle to be charged.

24. The charging system according to claim 16, wherein said charging cable is configured for charging the electric vehicle with direct current.

25. The charging system according to claim 24, wherein said charging cable is configured for charging the electric vehicle with at least one of a charging current of at least 125 A or a charging voltage of at least 125 V.

26. The charging system according to claim 16, wherein the charging system is configured for use outdoors.

27. The charging system according to claim 16, which further comprises at least one sensor unit for determining a position of a charging socket of the electric vehicle to be charged.

28. The charging system according to claim 16, which further comprises:
a first charging device including said vertical charging arm part, said charging cable or busbar, and said horizontal charging arm part;
a second charging device including a vertical charging arm part, a charging cable or busbar, and a horizontal charging arm part being elongate and configured to be extended from said vertical charging arm part of said second charging device toward the electric vehicle;
said first and second charging devices being disposed to permit positioning of the electric vehicle to be charged between said first and second charging devices.

29. A method for autonomous charging of an electric vehicle, the method comprising:
providing a charging system according to claim 16;
positioning the electric vehicle to be charged in a vehicle region of the charging system;
autonomously ascertaining a target position for said vehicle-side end of said horizontal charging arm part;
autonomously positioning said vehicle-side end of said horizontal charging arm part in said target position; and
at least extending said horizontal charging arm part toward the electric vehicle by using said first drive system.

30. The method according to claim 29, which further comprises at least:
detecting measurement data dependent on a position of a charging unit of the electric vehicle by using a sensor unit of the charging system; and
determining said target position for the vehicle-side end of said horizontal charging arm part by using an evaluation unit of the charging system based on the detected measurement data.

31. The method according to claim 30, which further comprises, in step, performing the determination of said target position based on measurement data at least in part by using a trainable neural network of said evaluation unit.
